(19) United States
(12) Patent Application Publication
(10) Pub. No.: US 2012/0006014 A1
(43) Pub. Date: Jan. 12, 2012

(54) MULTI-SPEED HYDRAULIC JACK

(76) Inventors: George W. Jackson, Mississauga (CA); David G. Jackson, Mississauga (CA)

(21) Appl. No.: 12/990,216

(22) PCT Filed: Apr. 28, 2009
(86) PCT No.: PCT/CA2009/000563

§ 371 Date: May 11, 2011

Related U.S. Application Data
(60) Provisional application No. 61/048,931, filed on Apr. 29, 2008.

(30) Foreign Application Priority Data
Aug. 29, 2008 (CA) 2,639,246

(51) Int. Cl. F15B 7/06

(52) U.S. Cl. 60/424

(57) ABSTRACT

A multi-speed jack, having a pump assembly including a pump block having a first cylinder and a second cylinder defined therein, a piston assembly movable within the pump block, the piston assembly having a first portion configured to sealably engage with the first cylinder and a second portion configured to sealably engage with the second cylinder, a reservoir for storing hydraulic fluid and coupled to the pump block so that when the piston assembly is moved in a first direction, hydraulic fluid in the reservoir is supplied to the first cylinder and the second cylinder, a lifting assembly having a ram chamber and a ram rod, the ram chamber coupled to the pump assembly and configured to receive fluid from the first cylinder and the second cylinder when the piston assembly is moved in a second direction so as to raise the ram rod and a bypass check valve provided in the first cylinder. The bypass check valve is configured so that when the piston assembly is moving in the second direction and the pressure in the first cylinder exceeds a threshold pressure, the hydraulic fluid in the first cylinder returns to the reservoir. The second cylinder may be much smaller to provide leverage to move a far greater load though at a much slower rate.

### FIELD

Disclosed herein are apparatus related to hydraulic jacks, and in particular to multi-speed hydraulic jacks.

### SUMMARY

According to one embodiment, there is provided a multi-speed hydraulic jack configured to automatically operate in a first stage to quickly engage a load with a reduced number of strokes and in a second stage to more easily move the load, comprising a pump block having a larger cylinder and a smaller cylinder defined therein, a piston assembly movable within the pump block, the piston assembly having a larger portion configured to sealably engage with the larger cylinder and a smaller portion configured to sealably engage with the smaller cylinder, a reservoir for storing hydraulic fluid and coupled to the pump block so that when the piston assembly is moved in a first direction, hydraulic fluid in the reservoir is drawn into the larger cylinder and the smaller cylinder, a lifting assembly having a ram chamber and a ram rod, the ram chamber fluidly coupled to the large cylinder and small cylinder, and a bypass check valve provided in the large cylinder, the bypass check valve configured so that as the piston assembly is moved in a second direction, when the pressure in the larger cylinder is less than a threshold pressure, the jack operates in the first stage wherein the larger portion and smaller portion of the piston assembly push fluid into the ram chamber to quickly extend the ram rod, and when the pressure in the larger cylinder exceeds the threshold pressure, the jack operates in the second stage wherein the smaller portion of the piston assembly pushes fluid into the ram chamber to extend the ram rod while the larger portion of the piston assembly pushes fluid back to the reservoir.

According to another embodiment, there is provided a multi-speed hydraulic jack, comprising a pump block having a first cylinder and a second cylinder defined therein, a piston assembly movable within the pump block, the piston assembly having a first portion configured to sealably engage with the first cylinder and a second portion configured to sealably engage with the second cylinder, a reservoir for storing hydraulic fluid and coupled to the pump block so that when the piston assembly is moved in a first direction, hydraulic fluid in the reservoir is drawn into the first cylinder and the second cylinder, a lifting assembly having a ram chamber and a ram rod, the ram chamber fluidly coupled to the first and second cylinder, and a bypass check valve provided in the first cylinder, the bypass check valve configured so that as the piston assembly is moved in a second direction, when the pressure in the first cylinder is less than a threshold pressure, the first and second portions of the piston assembly push fluid into the ram chamber to extend the ram rod, and when the pressure in the first cylinder exceeds the threshold pressure, the second portion of the piston assembly pushes fluid into the ram chamber to extend the ram rod while the first portion of the piston assembly pushes fluid back to the reservoir.

The first cylinder may be a large cylinder having a larger diameter and the second cylinder may be a small cylinder having a smaller diameter. The small cylinder may be generally aligned with and located below the large cylinder

The piston assembly may include a stepped piston having a larger diameter portion sized and shaped to correspond to the larger diameter of the large cylinder and a smaller diameter portion sized and shaped to correspond to the smaller diameter of the small cylinder. The piston assembly may include an upper piston rod and a lower piston rod coupled to the upper piston rod, and the upper piston rod and lower piston rod may be vertically aligned.

The multi-speed jack may further comprise a tank block coupled to the pump block, the tank block having an outer reservoir tube and a ram tube, the ram tube having the ram chamber and the ram rod therein, and wherein the outer reservoir tube and ram tube cooperate to define the reservoir.

The multi-speed jack may further comprise a valve assembly coupled to the pump block, the valve assembly configured to allow the hydraulic fluid within the ram chamber to be selectively returned to the reservoir to retract the lifting assembly.

The multi-speed jack may further comprise an overload circuit configured to inhibit the pressure within the ram chamber from exceeding a maximum operating pressure. The overload circuit may include a throttling valve that restricts the flow of hydraulic fluid there through.

According to yet another embodiment, there is provided a multi-speed jack, comprising a reservoir for storing hydraulic fluid, a pump block having a larger cylinder and a smaller cylinder, the larger and smaller cylinders fluidly coupled to the reservoir, a piston assembly movable within the pump block, the piston assembly having a larger piston portion configured to sealably engage with the larger cylinder and a smaller piston portion configured to sealably engage with the smaller cylinder, and a lifting assembly having a ram tube and a movable ram rod provided within the ram tube, wherein the piston assembly is configured to draw fluid from the reservoir into the large cylinder and the small cylinder when the piston assembly is moved in a first direction, and wherein the large cylinder includes a bypass check valve configured so that as the piston assembly is moved in a second direction, when the pressure in the larger cylinder is less than a threshold pressure, the larger portion and smaller portion of the piston assembly push fluid into the ram tube to extend the ram rod, and when the pressure in the larger cylinder exceeds the threshold pressure, the smaller portion of the piston assembly pushes fluid into the ram tube to extend the ram rod while the larger portion of the piston assembly pushes fluid back to the reservoir.

In some embodiments, the jack is configured to allow the fluid in the small cylinder to provide considerably more leverage to put more pressure on the ram rod (e.g. the ram rod can have a much greater size than the small cylinder), while the large cylinder may be similarly sized to the ram rod (and thus only exert about the same force as the ram rod).

### BRIEF DESCRIPTION OF THE DRAWINGS

The drawings included herewith are for illustrating various examples of methods and apparatus of the present specification and are not intended to limit the scope of what is taught in any way. In the drawings:

FIG. 1 shows an elevation view of a multi-speed hydraulic jack according to one embodiment;

FIG. 2 shows a cross-sectional elevation view of the multi-speed hydraulic jack of FIG. 1;

FIG. 3 shows a cross-sectional plan view of the multi-speed jack of FIG. 1 taken through line 3-3;

FIG. 4 shows a partial cross-sectional plan view of the pump body of the multi-speed jack of FIG. 1 taken through line 4-4;

FIG. 5 is a top plan view of the tank block of the multi-speed jack of FIG. 1 taken along line 5-5; and

FIG. 6 shows a schematic illustration of a hydraulic circuit for the multi-speed jack of FIG. 1.

### DETAILED DESCRIPTION

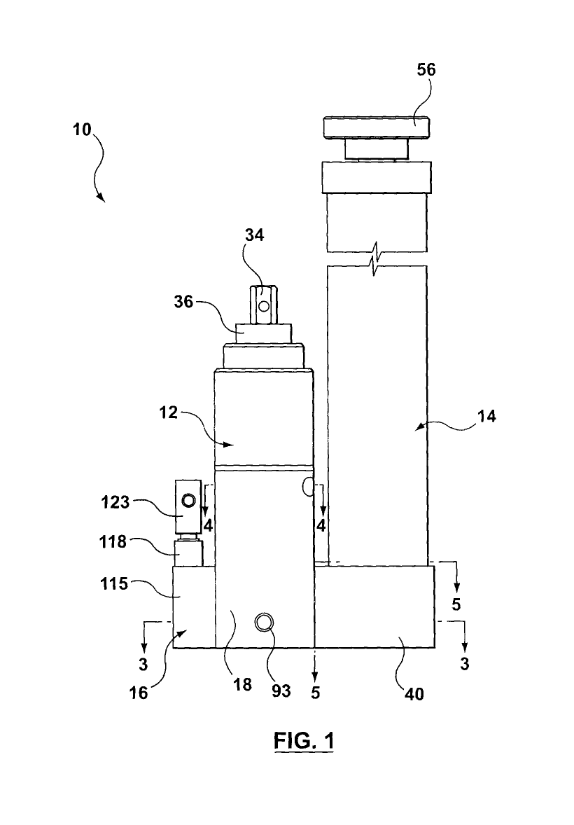

FIG. 1 shows a multi-speed hydraulic jack 10, also called a multi-stage jack. The jack 10 generally includes a pump assembly 12, a ram assembly 14 coupled to the pump assembly 12, and a valve assembly 16 coupled to the pump assembly 12. In some embodiments, the pump assembly 12, ram assembly 14 and valve assembly 16 may be separate components. In other embodiments, the pump assembly 12, ram assembly 14 and valve assembly 16 may be made as one assembly, with slight modifications in the fluid flow as shown herein.

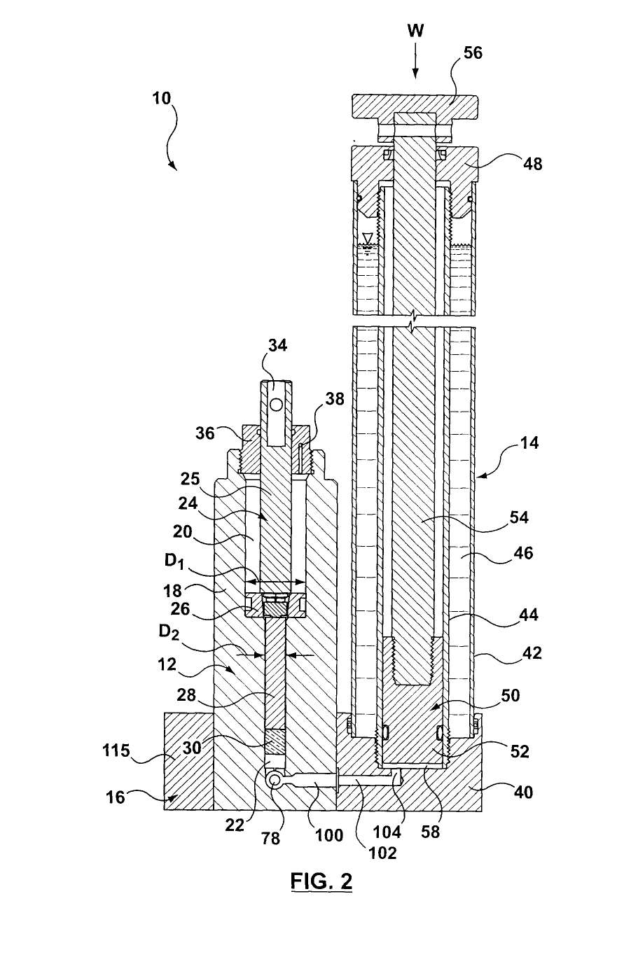

As shown in FIG. 2, the pump assembly 12 includes a pump body 18, which in some examples may be a machined block of metal (e.g. steel, aluminum, etc.). The pump body 18 generally defines two cavities therein, including a large cylinder 20 having a larger diameter D₁, and a small cylinder 22 having a smaller diameter D₂. As shown, the large cylinder 20 and the small cylinder 22 may be generally continuous, with the small cylinder 22 generally aligned with and located below the large cylinder 20.

Provided within the large cylinder 20 and small cylinder 22 is a piston assembly 24 configured for pumping hydraulic fluid. The piston assembly 24 generally includes a stepped piston having a larger diameter portion sized and shaped to correspond to size of the large cylinder 20 and a smaller diameter portion sized and shaped to correspond to size of the small cylinder 22.

For example, as shown the piston assembly 24 may include an upper piston rod 25 having a piston ring portion 26 coupled thereto. The piston ring portion 26 is sized and shaped to correspond to the cross sectional profile of the large cylinder 20 (e.g. the ring portion 26 has a diameter that generally corresponds to the larger diameter D₁) so as to provide a seal between the piston ring portion 26 and the walls of the large cylinder 20. Accordingly, as the piston ring portion 26 moves within the large cylinder 20, hydraulic fluid may be drawn into and pumped out of the large cylinder 20.

In some embodiments, the piston ring portion 26 may include a hydraulic sealing member configured to further facilitate sealing the piston ring portion 26 to the walls of the large cylinder 20 (for example a ring made of a rubber or other suitable material may be provided around the perimeter of the ring portion 26).

As shown, the piston assembly 24 also includes a lower piston rod 28 coupled to the upper piston rod 26. In some examples, the upper piston rod 25 and lower piston rod 28 may be a continuous member. As shown, in some examples, the upper piston rod 25 and lower piston rod 28 may be generally coaxial, with the piston rods 26, 28 vertically aligned.

The lower piston rod 28 includes an end cap 30 sized and shaped to correspond to the cross sectional profile of the small cylinder 22 (e.g. the end cap 30 has a diameter that generally corresponds to the smaller diameter D₂) so as to provide a seal between the walls of the small cylinder 22 and the end cap 30. Accordingly, as the end cap 30 moves within the small cylinder 22, hydraulic fluid may be drawn into and pumped out of the small cylinder 22.

The end cap 30 may be part of the lower piston rod 28 (e.g. may be formed integrally therewith) or may be a separate component. The end cap 30 may be made of any suitable material, for example metal, rubber or plastic, and may be threadably engaged with the lower piston rod 28 when the end cap is a separate component 30.

In some examples, the diameter of the lower piston rod 28 may be sized sufficiently smaller than the smaller diameter D₂ of the small cylinder 22 to accommodate irregular manufacturing tolerances such that the piston rod 28 will tend not contact the walls of the small cylinder 22 during movement of the piston assembly 24. The size and shape of the large cylinder 20, small cylinder 22, upper piston rod 25 and lower piston rod 28 and the lifting assembly 50 may be generally varied to achieve the desired speed and power required.

As shown, the piston assembly 24 also has an upper end 34 that can be coupled to an actuator (e.g. a lever or other driver, and which may be motorized or manual) for moving the piston assembly 24 within the pump body 18. For example, an operator may move a pump lever coupled to the upper end 34 of the piston assembly 24 to use the jack 10 to raise or move a load W, as will be described in greater detail below.

The pump assembly 12 may also include a plug 36 that engages with the pump body 18 (e.g. via a threaded portion) at an upper end of the large cylinder 20. The plug 36 generally secures and guides the piston assembly 24 within the pump body 18. In some embodiments, the plug 36 may include a breathing tube or hole 38 for allowing air to flow between the large cylinder 20 and ambient air surrounding the jack 10 to inhibit the formation of a vacuum within the large cylinder 20 which could otherwise tend to interfere with the operation of the jack 10.

As shown in FIG. 2, the ram assembly 14 generally includes a tank block 40 coupled to or forming part of the pump body 18. Secured to the tank block 40 are both an outer reservoir tube 42 and a ram tube 44 provided within the outer reservoir tube 42. The ram tube 44 acts as in inner reservoir tube. The ram tube 44 may be coupled to the tank block in any suitable manner, such as via threaded portions that engage with threads provided in the tank block 40 thus holding the reservoir tube 42 in place and to allow for sealing the reservoir tube 42.

The outer reservoir tube 42 and ram tube 44 (e.g. the inner reservoir tube) generally cooperate to define a reservoir 46 or “tank” creating a space for storing hydraulic fluid.

The reservoir 46 may be sealed at the top end by a reservoir cap 48 coupled to the inner ram tube 44 (as shown by threaded engagement), which holds the reservoir tube 42 in place. The cap 48 may also guide the movement of a ram rod 54 within the ram tube 44.

The outer reservoir tube 42 and ram tube 44 may be made of pipe or tubing of various thickness selected to accommodate the lifting assembly 50 and the hydraulic pressure generated within the jack 10, as will be understood by a person of skill in the art.

Provided within the ram tube 44 is a lifting assembly indicated generally as 50. The lifting assembly 50 includes a bottom end cap 52 sized and shaped to provide a seal between the end cap 52 and the inner walls of the ram tube 44. The lifting assembly 50 also includes the ram rod 54 coupled to the bottom end cap 52, and a top cap 56 coupled to the top of the ram rod 54.

As will be described in greater detail below, as hydraulic fluid is pumped from the reservoir 46 into a ram chamber 58 defined within the ram tube 44, the hydraulic fluid will act against the bottom end cap 52 and cause the lifting assembly 50 to extend so that the top cap 56 may be used to move a load W.

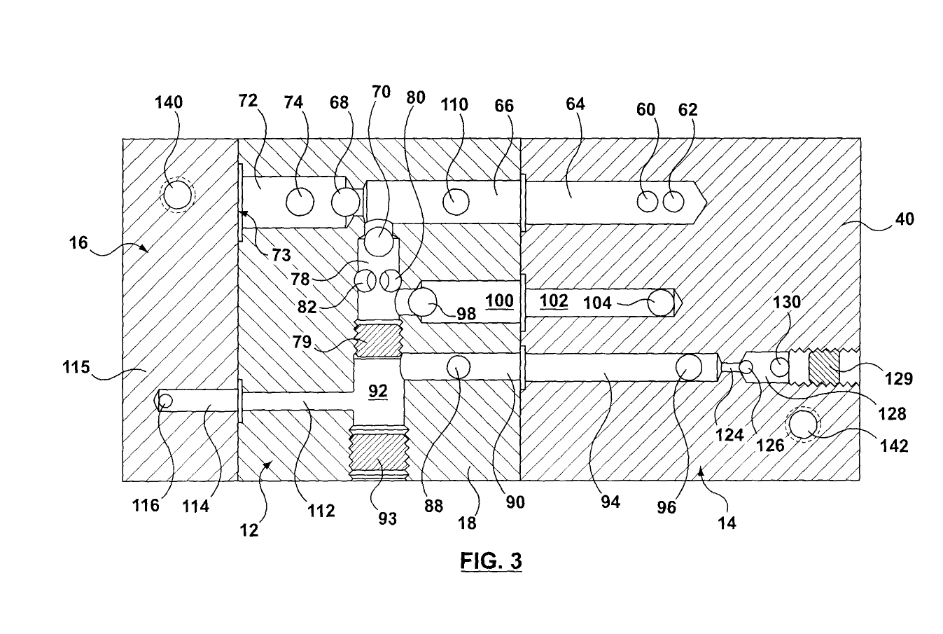

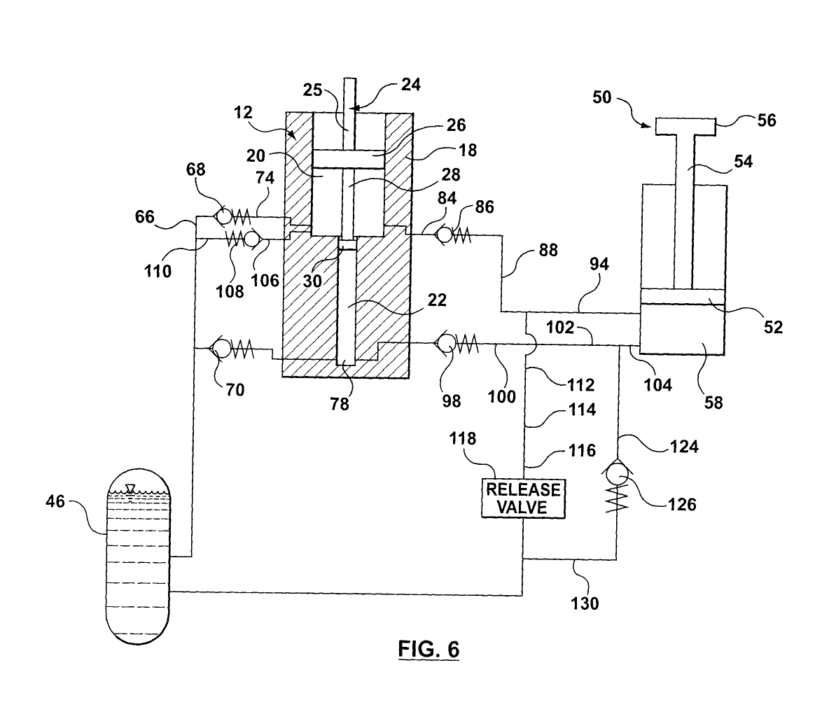

Turning now to FIGS. 3 to 6, further details of the jack 10 will be described with reference to an exemplary use. Generally speaking, the jack 10 may operate in at least two stages or speeds (e.g. the jack 10 has two or more lifting or extending capacities at two or more speeds).

Generally, before the top cap 56 has engaged the load W, it is desirable that the top cap 56 be moved to engage the load W quickly (i.e. in a short amount of time and/or requiring a reduced number of actuator movements by the operator). Accordingly, the jack 10 operates in a first stage where the jack 10 is configured to provide for a relatively large amount movement of the top cap 56 for each stroke of the piston assembly 24, generally until the top cap 56 engages the load W, and which may be in any direction (e.g. the load W could be lifted vertically, pushed horizontally, pushed downwards, etc.)

Once the top cap 56 engages the load W, the hydraulic pressure in the jack 10 between the large cylinder 20, the small cylinder 22 and the ram chamber 58 will increase. Accordingly, the amount of force required to move the piston assembly 24 to cause the lifting assembly 50 to move the load W also increases (generally in proportion to the weight or amount of the load W).

When the load W is of a sufficient weight or resistance, the jack 10 will automatically switch to operate in a second stage so that the top cap 56 moves a relatively small amount for each stroke of the piston assembly 24 but providing extra leverage to raise or move the load W with reduced force required.

Generally, the stepped piston in the piston assembly 24 and a bypass valve 108 cooperate to automatically create the varying speeds and lifting (pressure) forces, without requiring manual opening or closing of any valves, or the use of separately moving pistons which could complicate the design, take extra time and increase the costs and risks of accidents.

Each stroke of the piston assembly 24 generally includes two phases: an intake stroke in a first direction (described here as an upstroke) wherein fluid is drawn into the pump body 18 from the reservoir 46, and an output stroke in a second direction (shown here as a down stroke) wherein fluid is expelled from the pump body 18 into the ram chamber 58 to raise or extend the lifting assembly 50.

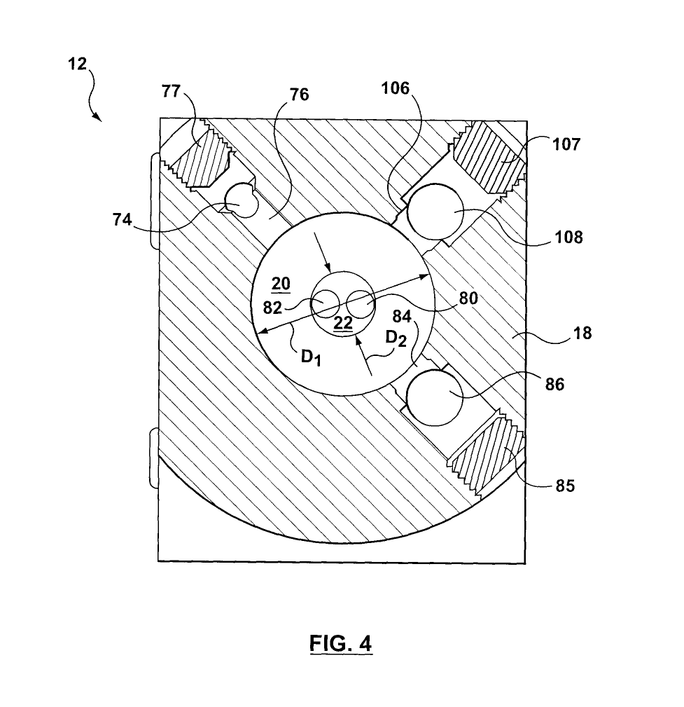

For example, during the upstroke, an operator may move the piston assembly 24 upwards within the pump body 18 using an actuator (e.g. a pump lever). This movement draws fluid from the reservoir 46 into the large cylinder 20 and small cylinder 22 via hydraulic passageways and ports as shown in FIGS. 3 and 4.

In particular, as the piston assembly 24 moves upwards, hydraulic fluid is drawn from the reservoir 46 through two ports 60, 62 and into a first passageway 64 in the tank block 40. The first passageway 64 is in fluid communication with a second passageway 66 in the pump body 18.

As will be appreciated by those skilled in the art, the various passageways described herein are coupled together and may include o-rings, gaskets, and/or use other sealing techniques as known in the art to inhibit leaking of hydraulic fluid.

In particular, providing the pump assembly 12, the ram assembly 14 and valve assembly 16 as separate components with hydraulic passageways joined in this manner tends to allow for easier manufacturing of the components and assemblies of the jack 10. However, the pump assembly 12, the ram assembly 14 and valve assembly 16 may be parts of one continuous assembly with slight modifications.

During the upstroke, hydraulic fluid that is drawn in the cylinders 20 and 22 continues to move within the second passageway 66 and through a large cylinder check valve 68 and a small cylinder check valve 70. The check valves 68, 70 may be each be a conventional spring loaded ball-valve that includes a small or light (e.g. low force) spring that biases a ball against a valve seat, as is generally known and often used.

Fluid drawn through the large cylinder check valve 68 then continues into a third passageway 72 (which may be sealed at the opposite end by the wall 73 of the valve assembly 16, as shown, or using a plug stop) and then flows or is drawn upwards through a first generally vertical conduit 74, then into the large cylinder 20 via a fourth passageway 76 (as shown in FIG. 4). As shown, the fourth passageway 76 may sealed at the opposite end (e.g. away from the large cylinder 20) by a threaded plug 77.

Similarly, fluid drawn through the small cylinder check valve 70 continues into a first lower chamber 78 in the pump body 18, and then flows or is drawn through two fluid ports 80, 82 into the small cylinder 22.

It will be understood that one fluid port may be used instead of two fluid ports 80, 82, but that the use of two or more ports 80, 82 may allow the ports 80, 82 to be sized smaller than the ball in the check valve 70, which will prevent the ball from passing through the ports 80, 82 while generally still allowing sufficient quantities of fluid to pass there through for the jack 10 to operate.

Generally, the small cylinder 22 and large cylinder 20 are not in fluid communication with each other when the piston assembly 24 is operating, and will separately draw in fluid to fill each of the respective cylinders 20, 22, as the sealed end cap 30 will inhibit the movement of hydraulic fluid between the large cylinder 20 and small cylinder 22. Thus, each of the small cylinder 22 and large cylinder 20 normally requires a separate hydraulic feed intake (e.g. through check valves 68, 70 as shown in FIG. 3).

Once the piston assembly 24 reaches the top of the upstroke (for example, when the top of the piston ring portion 26 engages or is adjacent the plug 36, or when another mechanical hard-stop is engaged, such as the actuator reaching the end of its range of motion), the large cylinder 20 and small cylinder 22 are generally full or at least have sufficient hydraulic fluid such that the down stroke can begin.

The operator can then use an actuator to move the piston assembly 24 downwards within the pump body 18. During the down stroke, as the piston assembly 24 moves downwards, the sealed piston ring portion 26 and sealed end cap 30 apply a downward pressure on the fluid. As this happens, the check valves 68, 70 are forced closed by their springs and by the hydraulic pressure in the in the passageway 72 and chamber 78 acting on the valves 68, 70, inhibiting fluid from flowing back through the passageways 64, 66 and into to the reservoir 46. Accordingly, the fluid in the cylinders 20, 22 must find different flow paths, which will depend on whether the jack 10 is operating in the first stage or the second stage (which depends on the load W).

When there is only a minimal or no load on the lifting assembly 50 (e.g. less than 50 lbs, less than 100 lbs, or some other predetermined value), the hydraulic pressure within the large cylinder 20 will be below a predetermined threshold pressure P₁ as controlled by a load spring behind the ball of the bypass valve 108 and the jack 10 will operate in the first stage.

However, when the load W on the lifting assembly 50 exceeds a certain weight or force (i.e. 50 lbs, 100 lbs, or some other predetermined value), the pressure within the large cylinder 20 will exceed the threshold pressure P₁ at the ball of the bypass valve 108, causing the jack 10 to operate in the second stage.

In particular, during a down stroke when the jack 10 is operating in the first stage, fluid within the large cylinder 20 fills the third passageway 72 and the first vertical conduit 74 (and is blocked by the valve 68), and flows into a fifth passageway 84 past a third light spring check valve 86, and then downwards through a second vertical conduit 88 (hidden below the check valve 86 in FIG. 4 but shown in FIG. 3) and into a first outlet passageway 90 in the pump block 18. The fifth passageway 84 is sealed at the opposite end by a threaded plug 85.

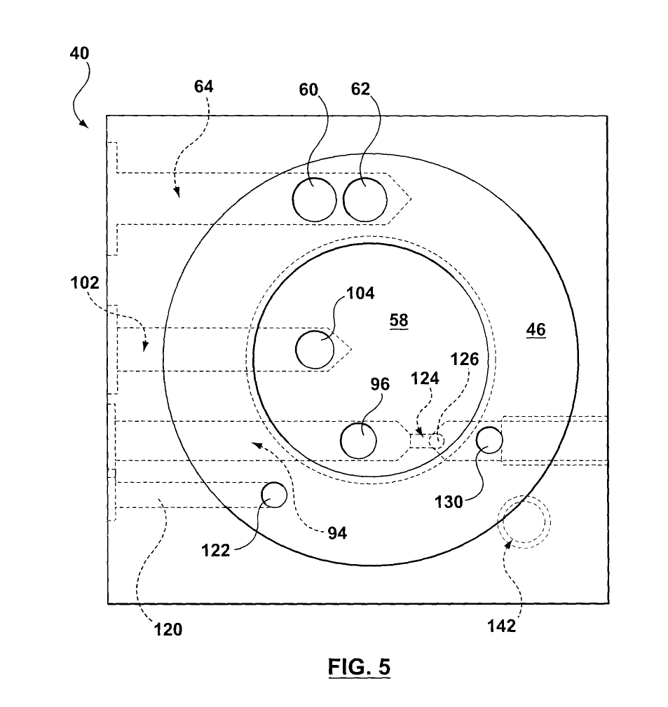

The first outlet passageway 90 is in fluid communication with a second lower chamber 92 (which is coupled to the release valve 118 as described below). The first outlet passageway 90 is also in fluid communication with a second outlet passageway 94 provided in the tank block 40. Fluid coming from the large cylinder 20 flows from the first outlet passageway 90 into the second outlet passageway 94, through a first outlet port 96 and then into the ram chamber 58 (as shown in FIG. 5).

During the same down stroke, fluid in the small cylinder 22 is under pressure from the end cap 30 and is inhibited from returning to the reservoir 46 as the check valve 70 is forced closed (e.g. by the spring in the valve 70 and the hydraulic pressure acting on the valve 70). Therefore, fluid in the small cylinder 22 is forced from the first lower chamber 78 and flows through a fourth check valve 98 into a third outlet passageway 100 provided in the pump block 18. The third outlet passageway 100 is in fluid communication with a fourth outlet passageway 102 provided in the tank block 40. The fourth outlet passageway 102 in turn feeds the fluid into the ram chamber 58 via a second outlet port 104 (as shown in FIGS. 3 and 5).

As fluid flows into the ram chamber 58 (from the first and second outlet ports 96, 104), the pressure in the ram chamber 58 will increase and cause the lifting assembly 50 to rise. When the jack 10 is operating in the first stage, fluid is flowing from both the large cylinder 20 and the small cylinder 22 into the ram chamber 58, and thus the top cap 56 may experience a relatively large amount of motion for each stroke of the piston assembly 24 (where there is little or no load W to lift for each stroke of the piston assembly 24).

The upstroke and down stroke cycles can continue with the jack 10 operating in the first stage until the top cap 56 encounters the load W and the hydraulic pressure in the large cylinder 20 exceeds the threshold pressure P₁.

Once the threshold pressure P₁ at the bypass valve 108 is exceeded, the jack 10 automatically enters the second stage. In particular, hydraulic pressure acting in a sixth passageway 106 connected to the large cylinder 20 will exceed the cracking pressure of the bypass check valve 108, and allow the fluid under the sealed piston ring 26 in the large cylinder 20 to return to the reservoir 46. Specifically, continuing the down stroke, the fluid within the large cylinder 20 under the piston ring portion 26 now flows through the passageway 106, past the bypass valve 108 and down a third vertical conduit 110 (shown in FIG. 3). Vertical conduit 110 in turn feeds the hydraulic fluid back through passageways 64, 66 and ports 60, 62 and into the reservoir 46.

In this manner, the pressure in the large cylinder 20 will not exceed the predetermined threshold pressure P₁. Accordingly, the amount of force required by an operator to move the lifting assembly 50 when the jack 10 is operating in the second stage will depend primarily on the pressure exerted in the small cylinder 22, which depends on the load W to be lifted, the diameter of the end cap 30 and the diameter of the bottom end 52 of the lifting assembly 50, but can be kept within a desired range.

The required leverage may be obtained to raise much heavier loads W with the same force than if just the larger diameter piston ring portion 26 were used, and also provides the advantage of getting the top cap 56 up to the load 10 many times faster (e.g. in some cases in ten strokes instead of eighty strokes).

The bypass check valve 108 may be a spring loaded valve that include a spring that biases a ball against a valve seat, as is generally known. The bypass valve 108 generally includes a spring stronger than the springs used in the light spring check valves (e.g. valve 86 and check valves 68, 70). Specifically, the spring in the bypass valve 108 may be selected to be sufficiently resilient to resist separation of the ball from the valve seat until the load W on the lifting assembly exceeds the predetermined weight (e.g. 50 lbs, 100 lbs, etc.) to allow for the starting fast lift when the jack 10 is operating in the first stage.

Turning to FIGS. 1, 3 and 5, the jack 10 also includes the valve assembly 16 having a valve block 115. The valve assembly 16 is generally configured to allow an operator to release the pressure within the ram chamber 58, to allow the lifting assembly 50 to be lowered or retracted.

In particular, as shown in FIG. 3, the second lower chamber 92 is in fluid communication with a first valve passageway 112 provided in the pump block 18, which in turn is in communication with a second valve passageway 114 provided in the valve block 115. The second valve passageway 114 is in fluid communication with a valve conduit 116 that connects to a release valve 118 shown in FIG. 1.

During operation of the jack 10 (i.e. when the jack 10 is being used to lift the load W), the release valve 118 is normally kept closed so that fluid is inhibited from flowing through the release valve 118.

However, when it is desired to lower the load W, the release valve 118 may be opened, allowing high-pressure fluid in the ram chamber 58 to flow out the port 96, through passageways 90, 94 into the second lower chamber 92, through the valve passageways 112, 114 and up the conduit 116. From here, the fluid continues through the release valve 118 (now open), through a third valve passageway (not shown) in the valve block 115 and pump block 18 (generally located above the valve passageways 112, 114) and into a fourth valve passageway 120 in the tank block 40, flowing back into the reservoir 46 through a valve port 122 (as shown in FIG. 5).

In this manner, the lifting assembly 50 may be controllably lowered by allowing fluid in the ram chamber 58 to return to the reservoir 46. In some examples, the release valve 118 may be configured to be operated by hand, for example by turning a valve actuator 123.

The jack 10 may also include an overload circuit to inhibit the pressure within the ram chamber 58 from exceeding a maximum operating pressure P. The maximum operating pressure Pₘₐₓ may be selected so as to inhibit damage to the components of the jack 10, for example where the operator attempts to lift a load W that is beyond the design limits of the jack 10 (e.g. a load greater than 4000 lbs, a load greater than 8000 lbs, etc.).

Without an overload circuit, when trying to lift especially heaving loads W, the pressure within the jack 10 may exceed safe limits, and the components of the jack may become damaged or may fail, and could cause injury to the operator or other persons nearby.

In the overload circuit shown in FIGS. 3 and 5, the second outlet passageway 94 is in fluid communication with a first overload passageway 124 sealed by an overload valve 126. The overload valve 126 may be a conventional ball-spring valve with the spring being selected such that the ball remains engaged with the valve seat until the pressure in the first overload passageway 124 exceeds the maximum operating pressure Pₘₐₓ.

When the pressure in the first overload passageway 124 exceeds Pₘₐₓ, the overload valve 126 opens and then fluid flows from the ram chamber 58, through the first overload passageway 124, past the valve 126 and into a second overload passageway 128 (sealed at the opposite end by a threaded plug 129). From the second overload passageway 128, the fluid returns to the reservoir 46 via an overload conduit 130 (as shown in FIG. 5).

As shown, the first overload passageway 124 may be narrower than the second overload passageway 128, and thus the first overload passageway 124 may act as a throttling valve that restricts or slows the flow of hydraulic fluid there through so as to enable the use of a much smaller spring behind the ball valve 126 when the maximum operating pressure Pₘₐₓ is exceeded.

In some examples, the jack 10 may be secured to a work surface (e.g. a surface on a movable cart having a wheeled frame) for example using fasteners that engage with threaded apertures 140, 142 in the valve block 115 and tank block 40, respectively.

What has been described is merely some examples of an embodiment of the invention. Other systems, apparatuses and methods may be implemented by those skilled in the art without departing from the present invention, the scope of which is defined by the following claims. In particular, hydraulic jacks can generally be used to move loads in any and all directions and small pistons can be used to exert many more times the force as compared to larger pistons when properly configured. The claimed inventions are not limited to systems, apparatus or methods having all of the features of the examples described.

1. A multi-speed hydraulic jack configured to automatically operate in a first stage to quickly engage a load with a reduced number of strokes and in a second stage to more easily move the load, comprising:
a. a pump block having a larger cylinder and a smaller cylinder defined therein;
b. a piston assembly movable within the pump block, the piston assembly having a larger portion configured to sealably engage with the larger cylinder and a smaller portion configured to sealably engage with the smaller cylinder;
c. a reservoir for storing hydraulic fluid and coupled to the pump block so that when the piston assembly is moved in a first direction, hydraulic fluid in the reservoir is drawn into the larger cylinder and the smaller cylinder;
d. a lifting assembly having a ram chamber and a ram rod, the ram chamber fluidly coupled to the large cylinder and small cylinder; and
e. a bypass check valve provided in the large cylinder, the bypass check valve configured so that as the piston assembly is moved in a second direction, when the pressure in the larger cylinder is less than a threshold pressure, the jack operates in the first stage wherein the larger portion and smaller portion of the piston assembly push fluid into the ram chamber to quickly extend the ram rod, and when the pressure in the larger cylinder exceeds the threshold pressure, the jack operates in the second stage wherein the smaller portion of the piston assembly pushes fluid into the ram chamber to extend the ram rod while the larger portion of the piston assembly pushes fluid back to the reservoir.

2. A multi-speed hydraulic jack, comprising:
a. a pump block having a first cylinder and a second cylinder defined therein;
b. a piston assembly movable within the pump block, the piston assembly having a first portion configured to sealably engage with the first cylinder and a second portion configured to sealably engage with the second cylinder;
c. a reservoir for storing hydraulic fluid and coupled to the pump block so that when the piston assembly is moved in a first direction, hydraulic fluid in the reservoir is drawn into the first cylinder and the second cylinder;
d. a lifting assembly having a ram chamber and a ram rod, the ram chamber fluidly coupled to the first and second cylinders; and
e. a bypass check valve provided in the first cylinder, the bypass check valve configured so that as the piston assembly is moved in a second direction, when the pressure in the first cylinder is less than a threshold pressure, the first and second portions of the piston assembly push fluid into the ram chamber to extend the ram rod, and when the pressure in the first cylinder exceeds the threshold pressure, the second portion of the piston assembly pushes fluid into the ram chamber to extend the ram rod while the first portion of the piston assembly pushes fluid back to the reservoir.

3. The multi-speed jack of claim 2, wherein the first cylinder is a large cylinder having a larger diameter and the second cylinder is a small cylinder having a smaller diameter.

4. The multi-speed jack of claim 3, wherein the small cylinder is generally aligned with and located below the large cylinder

5. The multi-speed jack of claim 4, wherein the piston assembly includes a stepped piston having a larger diameter portion sized and shaped to correspond to the larger diameter of the large cylinder and a smaller diameter portion sized and shaped to correspond to the smaller diameter of the small cylinder.

6. The multi-speed jack of claim 5, wherein the piston assembly includes an upper piston rod and a lower piston rod coupled to the upper piston rod, and the upper piston rod and lower piston rod are vertically aligned.

7. The multi-speed jack of claim 2, further comprising a tank block coupled to the pump block, the tank block having an outer reservoir tube and a ram tube, the ram tube having the ram chamber and the ram rod therein, and wherein the outer reservoir tube and ram tube cooperate to define the reservoir.

8. The multi-speed jack of claim 2, further comprising a valve assembly coupled to the pump block, the valve assembly configured to allow the hydraulic fluid within the ram chamber to be selectively returned to the reservoir to retract the lifting assembly.

9. The multi-speed jack of claim 2, further comprising an overload circuit configured to inhibit the pressure within the ram chamber from exceeding a maximum operating pressure

10. The multi-stage jack of claim 9, wherein the overload circuit includes a throttling valve that restricts the flow of hydraulic fluid there through.

11. A multi-speed jack, comprising:
a. a reservoir for storing hydraulic fluid;
b. a pump block having a larger cylinder and a smaller cylinder, the larger and smaller cylinders fluidly coupled to the reservoir;
c. a piston assembly movable within the pump block, the piston assembly having a larger piston portion configured to sealably engage with the larger cylinder and a smaller piston portion configured to sealably engage with the smaller cylinder; and
d. a lifting assembly having a ram tube and a movable ram rod provided within the ram tube;
e. wherein the piston assembly is configured to draw fluid from the reservoir into the large cylinder and the small cylinder when the piston assembly is moved in a first direction; and
f. wherein the large cylinder includes a bypass check valve configured so that as the piston assembly is moved in a second direction, when the pressure in the larger cylinder is less than a threshold pressure, the larger portion and smaller portion of the piston assembly push fluid into the ram tube to extend the ram rod, and when the pressure in the larger cylinder exceeds the threshold pressure, the smaller portion of the piston assembly pushes fluid into the ram tube to extend the ram rod while the larger portion of the piston assembly pushes fluid back to the reservoir.

12. The multi-speed jack of claim 11, wherein the smaller cylinder is generally aligned with and located below the larger cylinder

13. The multi-speed jack of claim 11 wherein the piston assembly includes an upper piston rod and a lower piston rod coupled to the upper piston rod, and the upper piston rod and lower piston rod are vertically aligned.

14. The multi-speed jack of claim 11, further comprising a tank block coupled to the pump block, the tank block having an outer reservoir tube and the ram tube coupled thereto, and wherein the outer reservoir tube and ram tube cooperate to define the reservoir.

15. The multi-speed jack of claim 11, further comprising a valve assembly coupled to the pump block, the valve assembly configured to allow the hydraulic fluid within the lifting assembly to be returned to the reservoir to retract the lifting assembly.

16. The multi-speed jack of claim 11, further comprising an overload circuit configured to inhibit the pressure within the ram tube from exceeding a maximum operating pressure

17. The multi-stage jack of claim 16, wherein the overload circuit includes a throttling valve that restricts the flow of hydraulic fluid there through.
